(19) United States
(12) Patent Application Publication
(10) Pub. No.: US 2026/0049565 A1
(43) Pub. Date: Feb. 19, 2026

(54) VEHICLE SYSTEM WITH INJECTION HOUSING AND TURBOCHARGER HAVING MOTOR

(71) Applicant: Cummins Emission Solutions Inc., Columbus, IN (US)

(72) Inventors: Samuel Johnson, East Wenatchee, WA (US); Chetan Kishorrao Chawane, Pune (IN); Donald Edward Willey, Huddersfield (GB); Matthew Robert Brookes, Holmfirth (GB)

(73) Assignee: Cummins Emission Solutions Inc., Columbus, IN (US)

(21) Appl. No.: 19/101,231

(22) PCT Filed: Jun. 26, 2023
(86) PCT No.: PCT/US2023/026188

§ 371 Date: Feb. 4, 2025

(30) Foreign Application Priority Data
Aug. 5, 2022 (IN) 202241044790

(51) Int. Cl. F01N 3/20; F01N 5/04; F02B 37/12; F02B 37/18

(52) U.S. Cl. CPC F01N 3/2066; F01N 5/04; F02B 37/183; F01N 2610/02; F02B 2037/122

(57) ABSTRACT

A vehicle system includes a turbocharger having a turbine that receives exhaust from an engine-turbine exhaust conduit, a shaft coupled to the turbine, and a motor coupled to the shaft. The vehicle system further includes a controller that causes the motor to rotate the shaft. The vehicle system further includes an injection housing directly coupled to the turbine or to a turbine-housing exhaust conduit that is directly coupled to the turbine. The injection housing receives the exhaust from the turbine or from the turbine-housing exhaust conduit. The vehicle system further includes a dosing module coupled to the injection housing. The dosing module includes an injector configured to inject treatment fluid into the injection housing.

### CROSS-REFERENCE TO RELATED APPLICATION

This application claims the benefit of and priority to India Provisional Patent Application No. 202241044790, filed Aug. 5, 2022, which is incorporated herein by reference in its entirety.

### TECHNICAL FIELD

The present application relates generally to a vehicle system that includes a turbocharger, an injection housing, and a dosing module coupled to the injection housing.

### BACKGROUND

For internal combustion engines, such as diesel engines, nitrogen oxide (NOₓ) compounds may be emitted in exhaust. It may be desirable to reduce NOₓ emissions, for example, to comply with environmental regulations. To reduce NOₓ emissions, a treatment fluid (e.g., reductant, etc.) may be injected (e.g., dosed, etc.) into the exhaust by a dosing system and within a vehicle system (e.g., an exhaust aftertreatment system, etc.). The treatment fluid facilitates conversion of a portion of the exhaust into non-NOₓ emissions, such as nitrogen (N₂), carbon dioxide (CO₂), and water (H₂O), thereby reducing NOₓ emissions.

### SUMMARY

In one embodiment, a vehicle system includes a turbocharger having a turbine that receives exhaust from an engine-turbine exhaust conduit, a shaft coupled to the turbine, and a motor coupled to the shaft. The vehicle system further includes a controller that causes the motor to rotate the shaft. The vehicle system further includes an injection housing directly coupled to the turbine or to a turbine-housing exhaust conduit that is directly coupled to the turbine. The injection housing receives the exhaust from the turbine or from the turbine-housing exhaust conduit. The vehicle system further includes a dosing module coupled to the injection housing. The dosing module includes an injector that injects treatment fluid into the injection housing.

In another embodiment, a vehicle system includes a turbocharger. The turbocharger includes a turbine that receives exhaust from an engine-turbine exhaust conduit, a turbine shaft coupled to the turbine, a first motor coupled to the turbine shaft, and a compressor that provides air to an engine-compressor air conduit. The engine-compressor air conduit provides the air to an engine. The turbocharger further includes a compressor shaft coupled to the compressor. The compressor shaft is rotatable independent of the turbine shaft. The vehicle system further includes a controller that causes the first motor to rotate the turbine shaft and an injection housing directly coupled to the turbine or to a turbine-housing exhaust conduit that is directly coupled to the turbine. The injection housing receives the exhaust from the turbine or from the turbine-housing exhaust conduit. The vehicle system further includes a dosing module coupled to the injection housing. The dosing module includes an injector that injects treatment fluid into the injection housing.

In yet another embodiment, a vehicle system includes an engine that includes a crankshaft and a cylinder-piston assembly that rotates the crankshaft. The cylinder piston assembly includes a cylinder. The engine further includes a fuel injector corresponding to the cylinder-piston assembly. The fuel injector injects fuel into the cylinder. The vehicle system further includes a turbocharger that includes a turbine that receives exhaust from an engine-turbine exhaust conduit, a turbine shaft coupled to the turbine, a first motor coupled to the turbine shaft, and a compressor that provides air to an engine-compressor air conduit. The engine-compressor air conduit provides the air to the engine. The turbocharger further includes a compressor shaft coupled to the compressor and the crankshaft. The vehicle system further includes a controller that (i) causes the first motor to rotate the turbine shaft and (ii) controls fuel amount injected by the fuel injector based on a pressure of the air provided by the compressor to the engine via the engine-compressor air conduit. The vehicle system further includes an injection housing directly coupled to the turbine or to a turbine-housing exhaust conduit that is directly coupled to the turbine. The injection housing receives the exhaust from the turbine or from the turbine-housing exhaust conduit. The vehicle system further includes a dosing module coupled to the injection housing. The dosing module includes an injector that injects treatment fluid into the injection housing.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a block schematic diagram of an example vehicle system including a turbocharger;

FIG. 2 is a block schematic diagram of the turbocharger of FIG. 1;

FIG. 3 is a block schematic diagram of another example vehicle system;

FIG. 4 is a block schematic diagram of yet another example vehicle system;

FIG. 5 is a block schematic diagram of yet another example vehicle system;

FIG. 6 is a block schematic diagram of yet another example vehicle system;

FIG. 7 is a block schematic diagram of yet another example vehicle system;

FIG. 8 is a block schematic diagram of yet another example vehicle system;

FIG. 9 is a block schematic diagram of yet another example vehicle system;

FIG. 10 is a block schematic diagram of yet another example vehicle system,

FIG. 11 is a block schematic diagram of yet another example vehicle system;

FIG. 12 is a block schematic diagram of yet another example vehicle system including a heater;

FIG. 13 is a cross-sectional view of the heater of FIG. 12;

FIG. 14 is a block schematic diagram of yet another example vehicle system,

FIG. 15 is a block schematic diagram of yet another example vehicle system; and

FIG. 16 is a block schematic diagram of yet another example vehicle system.

It will be recognized that some or all of the Figures are schematic representations for purposes of illustration. The Figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and for providing an injection housing and a turbocharger with a motor for a vehicle system. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Internal combustion engines (e.g., diesel internal combustion engines, etc.) produce exhaust that contains constituents, such as NOₓ, N₂, CO₂, and/or H₂O. In some applications, a vehicle system (e.g., an exhaust aftertreatment system) includes a dosing module that treats the exhaust using a treatment fluid (e.g., reductant, etc.) released from the dosing module by an injector of a doser. The treatment fluid is adsorbed by a catalyst member (e.g., selective catalytic reduction (SCR) catalyst member). The adsorbed treatment fluid in the catalyst member functions to reduce NOₓ in the exhaust. The dosing module is mounted on a component of the vehicle system. For example, the dosing module may be mounted on a decomposition reactor, an exhaust conduit, a panel, or other similar components of the vehicle system.

Mixing the exhaust with the treatment fluid improves the reduction of NOx in the exhaust. A device can be used to facilitate mixing between the exhaust and the treatment fluid through turbulent flow (e.g., turbulence, etc.). Turbulence in the form of swirling (e.g., eddies, etc.) improves the mixing characteristics of a fluid. For example, swirling of the exhaust causes dispersal of treatment fluid within the exhaust, thereby improving the mixing between the exhaust and the treatment fluid. However, a device in a flow path of the treatment fluid may be prone to collecting (e.g., accumulating, etc.) deposits of the treatment fluid. These deposits may reduce a mixing efficiency of the device and a flow rate of the exhaust and/or the treatment fluid within a conduit that the device is within or fluidly coupled to.

Increasing a temperature of the catalyst member also improves the reduction of NOx in the exhaust. A heater can be added near the catalyst member. However, the heater adds to a design complexity of the vehicle system and it requires power to operate.

Implementations described herein are related to a vehicle system for an exhaust system with a turbocharger. The turbocharger includes a turbine, a shaft (e.g., a turbine shaft) coupled to the turbine, and a motor coupled to the turbine shaft. The turbine is configured to receive exhaust from the exhaust system and includes a wheel coupled to the shaft. The vehicle system further includes a controller (e.g., reductant delivery system controller) configured to cause the motor to rotate the turbine shaft and an injection housing directly coupled to the turbine or to a turbine-housing exhaust conduit that is directly coupled to the turbine. The injection housing is configured to receive the exhaust from the turbine or from the turbine-housing exhaust conduit. The vehicle system further includes a dosing module coupled to the injection housing. The dosing module includes an injector configured to inject treatment fluid into the injection housing.

At a peak (e.g., maximum, etc.) efficiency of the turbocharger, an exhaust outflow from the turbine is mostly axial (e.g., laminar, non-turbulent, etc.). Because there is little swirl in such exhaust outflow, mixing of reductant into the exhaust is minimal. Peak efficiency of the turbocharger occurs when a rotational speed of the wheel is set by a flow rate of the exhaust. In order to increase mixing, the controller can cause the motor to rotate the wheel via the turbine shaft at a different rotational speed, where the turbocharger is not at peak efficiency and the exhaust outflow from the turbine is less axial (e.g., more turbulent, includes more swirling, etc.). This lessens the need for a dedicated mixer.

The vehicle system further includes a housing-catalyst exhaust conduit directly coupled to the injection housing and a catalyst member coupled to the housing-catalyst exhaust conduit such that the catalyst member is directly coupled to the turbine. The turbine operates at a high temperature. Therefore, the temperature of the catalyst member will increase. This configuration allows for the temperature of the catalyst member to increase without the need of additional heaters.

### II. Vehicle System Overview

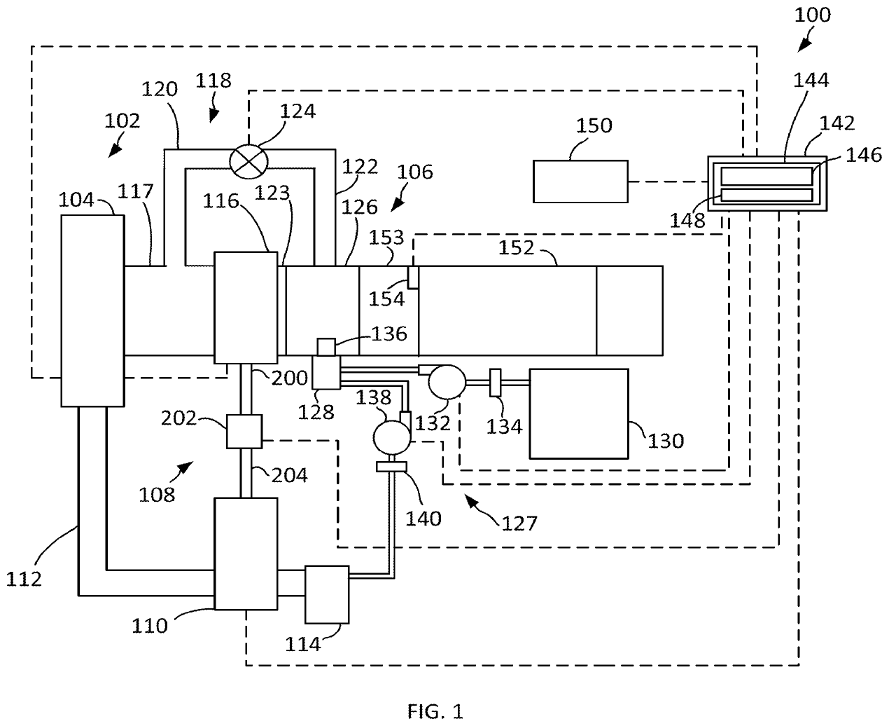

FIGS. 1, 3-12, and 14-16 depict various example vehicle systems 100. The vehicle system 100 may be implemented in a vehicle (e.g., truck, car, construction vehicle, military vehicle, commercial vehicle, etc.), a maritime vessel (e.g., ship, barge, boat, etc.), a generator, an aircraft (e.g., plane, jet, etc.), or other similar systems. The vehicle system 100 includes an exhaust system 102 and an internal combustion engine 104 (e.g., diesel internal combustion engine, diesel hybrid internal combustion engine, gasoline internal combustion engine, petrol internal combustion engine, liquid propane internal combustion engine, etc.).

The exhaust system 102 includes an exhaust conduit system 106. The exhaust conduit system 106 receives exhaust from the internal combustion engine 104 and provides the exhaust to atmosphere.

The exhaust system 102 also includes a turbocharger 108. The turbocharger 108 is configured to provide additional energy from the exhaust to the internal combustion engine 104. In this way, the turbocharger 108 can increase the output (e.g., power, etc.) and/or efficiency of the internal combustion engine 104. The turbocharger 108 includes a compressor 110. The compressor 110 is configured to receive air from an air source 114 (e.g., air intake, atmosphere, air cooler, etc.). The vehicle system 100 includes an engine-compressor air conduit 112 coupled to (e.g., attached to, fixed to, welded to, integrated with, etc.) the internal combustion engine 104 and the compressor 110. The compressor 110 is configured to compress the air and provide the air to the internal combustion engine 104 via the engine-compressor air conduit 112. The turbocharger 108 also includes a turbine 116. The vehicle system 100 includes an engine-turbine exhaust conduit 117 coupled to the internal combustion engine 104 and the turbine 116. The turbine 116 is configured to receive the exhaust from the internal combustion engine 104 via the engine-turbine exhaust conduit 117. The turbine 116 harnesses energy in the exhaust.

The vehicle system 100 also includes a bypass system 118 (e.g., wastegate system, blowoff system, etc.). As is explained in more detail herein, the bypass system 118 is configured to facilitate selective routing of the exhaust around the turbine 116, thereby decreasing pressure within the turbine 116. In this way, the bypass system 118 may provide a mechanism for protecting the turbine 116 against undesirable pressurization, thereby increasing a useful life of the turbine 116.

The bypass system 118 includes a bypass inlet conduit 120 (e.g., upstream bypass conduit, etc.). The bypass inlet conduit 120 is coupled to the engine-turbine exhaust conduit 117. The bypass system 118 also includes a bypass outlet conduit 122 (e.g., downstream bypass conduit, etc.). The bypass outlet conduit 122 is fluidly coupled to a turbine-housing exhaust conduit 123 of the exhaust conduit system 106. In various embodiments, the turbine-housing exhaust conduit 123 is directly coupled to the turbine 116. In other words, there are no intervening components between the turbine-housing exhaust conduit 123 and the turbine 116. In some embodiments, the turbine-housing exhaust conduit 123 is integrally formed with the turbine 116.

The bypass system 118 also includes a bypass valve 124 (e.g., control valve, solenoid valve, electronically controllable valve, ball valve, etc.). The bypass valve 124 is coupled to the bypass inlet conduit 120 and the bypass outlet conduit 122 and is operable (e.g., selectively repositionable, etc.) between (i) a first position, where flow of the exhaust from the bypass inlet conduit 120 to the bypass outlet conduit 122 is facilitated, and (ii) a second position, where flow of the exhaust from the bypass inlet conduit 120 to the bypass outlet conduit 122 is prohibited (e.g., blocked, prevented, etc.).

The vehicle system 100 also includes an injection housing 126 (e.g., conduit, decomposition reactor, reactor pipe, decomposition tube, reactor tube, etc.). The injection housing 126 is located immediately downstream of the turbine 116. In various embodiments, the injection housing 126 is directly coupled to the bypass outlet conduit 122. In some embodiments, the injection housing 126 is directly coupled to the turbine 116. In some embodiments, the injection housing 126 is integrally formed with the turbine 116 and/or the bypass outlet conduit 122.

As a result, the injection housing 126 receives exhaust that has flowed out of the turbine 116 and therefore has any swirl imparted by the turbine 116, as well as exhaust that has not flowed through the turbine 116 and instead has bypassed the turbine 116 via the bypass outlet conduit 122, when the bypass valve 124 is not in the second position (e.g., when the bypass valve 124 is in the first position, when the bypass valve 124 is between the first position and the second position, etc.). As is explained in more detail herein, the vehicle system 100 harnesses swirl imparted by the turbine 116 to facilitate mixing of the exhaust and reductant, thereby facilitating more desirable treatment of the exhaust. In various embodiments, the injection housing 126 is directly coupled to the internal combustion engine 104 and/or turbocharger 108 (e.g., via a mounting bracket, etc.). In some embodiments, the bypass outlet conduit 122 is shaped, angled, or otherwise configured to enhance the swirl of the exhaust within the injection housing 126.

In various embodiments, the bypass inlet conduit 120, the bypass outlet conduit 122, and the bypass valve 124 are separate from the turbine 116. In these embodiments, the bypass inlet conduit 120 is not coupled to the turbine 116, except via the engine-turbine exhaust conduit 117, the bypass outlet conduit 122 is not coupled to the turbine 116, except via the injection housing 126, and the bypass valve 124 is not coupled to the turbine 116. In such embodiments, the bypass inlet conduit 120 may be decoupled from the engine-turbine exhaust conduit 117 without decoupling the turbine 116 from the engine-turbine exhaust conduit 117, the bypass outlet conduit 122 may be decoupled from the injection housing 126 without decoupling the turbine 116 from the injection housing 126, and the bypass valve 124 may be decoupled from the bypass inlet conduit 120 and the bypass outlet conduit 122 without decoupling the turbine 116 from the engine-turbine exhaust conduit 117 or the injection housing 126.

In various embodiments, the bypass inlet conduit 120, the bypass outlet conduit 122, and the bypass valve 124 are coupled to the turbine 116. In some embodiments, the bypass inlet conduit 120, the bypass outlet conduit 122, and the bypass valve 124 are coupled to the turbine 116 along an external surface (e.g., housing, etc.) of the turbine 116. In other embodiments, the bypass inlet conduit 120, the bypass outlet conduit 122, and the bypass valve 124 are integrated within the turbine 116. In these embodiments, the bypass inlet conduit 120, the bypass outlet conduit 122, and the bypass valve 124 are positioned along a first channel (e.g., volute, etc.) in the turbine 116 such that the exhaust is configured to pass from the engine-turbine exhaust conduit 117 to the injection housing 126 through the first channel, and the exhaust passes from the engine-turbine exhaust conduit 117 to the injection housing 126 through a second channel (e.g., volute, etc.) in the turbine 116 that is separated from the first channel. In such embodiments, decoupling the turbine 116 from the engine-turbine exhaust conduit 117 simultaneously decouples the bypass inlet conduit 120 from the engine-turbine exhaust conduit 117 and decoupling the turbine 116 from the injection housing 126 simultaneously decouples the bypass outlet conduit 122 from the injection housing 126. In some embodiments, the bypass valve 124 is configured to be decoupled from the turbine 116 independent of the bypass inlet conduit 120 and the bypass outlet conduit 122 (e.g., for servicing of the bypass valve 124, etc.).

The vehicle system 100 also includes a reductant delivery system 127. The reductant delivery system 127 includes a dosing module 128 (e.g., doser, etc.) coupled to the injection housing 126 and configured to inject (e.g., dose, etc.) treatment fluid (e.g., reductant, etc.) into the injection housing 126. The treatment fluid may be, for example, urea, diesel exhaust fluid (DEF), Adblue®, a urea water solution (UWS), an aqueous urea solution (e.g., AUS32, etc.), liquid hydrocarbons, and other similar fluids. The dosing module 128 may include an insulator (e.g., thermal insulator, vibrational insulator, etc.) interposed between a portion of the dosing module 128 and the portion of the injection housing 126 on which the dosing module 128 is mounted.

The dosing module 128 is fluidly coupled to a reductant source 130. The reductant source 130 may include multiple reductant sources 130. The reductant source 130 may be, for example, a diesel exhaust fluid tank containing Adblue®. A reductant pump 132 (e.g., supply unit, etc.) is used to pressurize the treatment fluid from the reductant source 130 for delivery to the dosing module 128. In some embodiments, the reductant pump 132 is pressure controlled (e.g., controlled to obtain a target pressure, etc.).

The reductant pump 132 includes a reductant filter 134. The reductant filter 134 filters (e.g., strains, etc.) the treatment fluid prior to the treatment fluid being provided to internal components (e.g., pistons, vanes, etc.) of the reductant pump 132. For example, the reductant filter 134 may inhibit or prevent the transmission of solids (e.g., solidified reductant, contaminants, etc.) to the internal components of the reductant pump 132. In this way, the reductant filter 134 may facilitate prolonged desirable operation of the reductant pump 132. In some embodiments, the reductant pump 132 is coupled to a chassis of a vehicle associated with the vehicle system 100.

The dosing module 128 includes at least one injector 136. Each injector 136 is configured to inject the treatment fluid into the exhaust (e.g., within the injection housing 126, etc.). In some embodiments, the reductant delivery system 127 also includes an air pump 138. In these embodiments, the air pump 138 draws air from the air source 114. The air may be drawn through an air filter 140 disposed upstream of the air pump 138. The air pump 138 provides the air to the dosing module 128 via a conduit. In these embodiments, the dosing module 128 is configured to mix the air and the treatment fluid into an air-treatment fluid mixture and to provide the air-treatment fluid mixture into the injection housing 126. In other embodiments, the reductant delivery system 127 does not include the air pump 138. In such embodiments, the dosing module 128 is not configured to mix the treatment fluid with air.

In various embodiments, the dosing module 128 is coupled to the injection housing 126 at a location other than a top surface (e.g., relative to a ground surface upon which the exhaust system 102 is located, etc.) of the injection housing 126. For example, the dosing module 128 may be coupled to the injection housing 126 at a circumferential or perimetrical position that is between 45° and 180° relative to a vertical axis (i.e., an axis in the direction of gravity, etc.). In this way, the dosing module 128 may be removed from heat which accumulates and/or builds along the top surface of the injection housing 126 due to the inherent rising of heat (e.g., within air, along the injection housing 126, etc.).

As utilized herein, the term “axis” does not require a circular cross-sectional shape. Accordingly, a shape that is centered on an axis may have a cross-sectional shape, when taken along a plane orthogonal to the axis, that is circular, elliptical, oval, square, rectangular, triangular, polygonal, or otherwise similarly shaped.

The dosing module 128 and the reductant pump 132 are also electrically or communicatively coupled to a reductant delivery system controller 142. The reductant delivery system controller 142 is configured to control the dosing module 128 to inject the treatment fluid into the injection housing 126. The reductant delivery system controller 142 may also be configured to control the reductant pump 132.

The reductant delivery system controller 142 includes a processing circuit 144. The processing circuit 144 includes a processor 146 and a memory 148. The processor 146 may include a microprocessor, an application-specific integrated circuit (ASIC), a field-programmable gate array (FPGA), etc., or combinations thereof. The memory 148 may include, but is not limited to, electronic, optical, magnetic, or any other storage or transmission device capable of providing a processor, ASIC, FPGA, etc. with program instructions. This memory 148 may include a memory chip, Electrically Erasable Programmable Read-Only Memory (EEPROM), Erasable Programmable Read Only Memory (EPROM), flash memory, or any other suitable memory from which the reductant delivery system controller 142 can read instructions. The instructions may include code from any suitable programming language. The memory 148 may include various modules that include instructions which are configured to be implemented by the processor 146.

In various embodiments, the reductant delivery system controller 142 is configured to communicate with a central controller 150 (e.g., engine control unit (ECU), engine control module (ECM), etc.) of an internal combustion engine 104 having the vehicle system 100. In some embodiments, the central controller 150 and the reductant delivery system controller 142 are integrated into a single controller.

In some embodiments, the central controller 150 is communicable with a display device (e.g., screen, monitor, touch screen, heads up display (HUD), indicator light, etc.). The display device may be configured to change state in response to receiving information from the central controller 150. For example, the display device may be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller 150. By changing state, the display device may provide an indication to a user (e.g., operator, etc.) of a status (e.g., operation, in need of service, etc.) of the reductant delivery system 127.

The vehicle system 100 also includes a selective catalytic reduction (SCR) catalyst member 152. The SCR catalyst member 152 is coupled to a housing-catalyst exhaust conduit 153 that is coupled to the injection housing 126. The SCR catalyst member 152 is in close proximity to the turbine 116. As a result, the treatment fluid is injected by the injector 136 upstream of the SCR catalyst member 152 such that the SCR catalyst member 152 receives a mixture of the treatment fluid and exhaust. The treatment fluid droplets undergo the processes of evaporation, thermolysis, and hydrolysis to form non-NOₓ emissions (e.g., gaseous ammonia, etc.) within the injection housing 126, the SCR catalyst member 152, and/or the exhaust conduit system 106. The SCR catalyst member 152 is configured to assist in the reduction of NOₓ emissions by accelerating a NOₓ reduction process between the treatment fluid and the NOₓ of the exhaust into diatomic nitrogen, water, and/or carbon dioxide.

By being mounted in close proximity to the turbine 116, the SCR catalyst member 152 is provided with relatively high temperature exhaust, when compared to other aftertreatment systems where catalysts are mounted further downstream. Due to being exposed to this relatively high temperature exhaust, the SCR catalyst member 152 is configured to transition (e.g., warm up, etc.) from ambient temperature (e.g., when the internal combustion engine 104 is not producing exhaust, etc.) to an operating temperature significantly more quickly than catalysts in other aftertreatment systems where catalysts are mounted further downstream. Prior to reaching the operating temperature, a catalyst may not desirably assist in the reduction of NOₓ emissions. As a result of the SCR catalyst member 152 being mounted in close proximity to the turbine 116, the vehicle system 100 is more desirable than other aftertreatment systems where catalysts are mounted further downstream.

Additionally, mounting the SCR catalyst member 152 in close proximity to the turbine 116 enables an overall size of the vehicle system 100 to be less than other aftertreatment systems where catalysts are mounted further downstream.

Similarly, by utilizing the swirl produced by the turbine 116 and/or the injection housing 126, the vehicle system 100 does not necessarily require the use of a mixer (e.g., mixing device, etc.) upstream of the SCR catalyst member 152. As a result, the complexity and cost, of the vehicle system 100 is decreased competed to other aftertreatment systems which utilize mixers upstream of the catalyst. Additionally, the backpressure of the vehicle system 100 is decreased, which may increase the efficiency and/or performance of the internal combustion engine 104.

The injection housing 126 may include heat shields positioned around the dosing module 128 and/or the injector 136. The heat shields may mitigate transmission of heat to the dosing module 128 and/or the injector 136.

The vehicle system 100 may further include an oxidation catalyst (e.g., a diesel oxidation catalyst (DOC)) fluidly coupled to the exhaust conduit system 106 (e.g., downstream of the SCR catalyst member 152, upstream of the injection housing 126, upstream of the turbine 116, etc.) to oxidize hydrocarbons and carbon monoxide in the exhaust.

The injection housing 126 may include a flow guide extending across the injection housing 126 proximate the bypass outlet conduit 122, such that the flow guide is located within, or adjacent to, the exhaust provided by the bypass outlet conduit 122 into the injection housing 126. The flow guide may enhance the swirl of the exhaust provided by the bypass outlet conduit 122 into the injection housing 126. In some embodiments, the flow guide includes an aerofoil (e.g., airfoil, louvered, etc.) shape when viewed in cross-section along a plane such that a first axis upon which the bypass outlet conduit 122 is centered extends along the plane, a second axis upon which the injection housing 126 is centered extends along the plane, a leading edge of the flow guide disposed proximate the bypass outlet conduit 122, and a trailing edge of the flow guide opposite the leading edge.

The vehicle system 100 further includes an exhaust sensor 154. The exhaust sensor 154 is disposed downstream of the injection housing 126 upstream of the SCR catalyst member 152. The exhaust sensor 154 is configured to provide exhaust signals associated with the exhaust. The exhaust sensor 154 is electrically or communicatively coupled to the reductant delivery system controller 142. The reductant delivery system controller 142 is configured to receive the exhaust signals from the exhaust sensor 154. The reductant delivery system controller 142 is configured to determine a uniformity index (UI) based on each exhaust signal. The UI, a numerical value between zero and one, may be interpreted as a mixing measurement, where a fully mixed mixture (e.g., exhaust and treatment fluid mixture) produces a value of one and a non-fully mixed mixture produces a value less than one.

The vehicle system 100 may further include a particulate filter (e.g., a diesel particulate filter (DPF)) fluidly coupled to the exhaust conduit system 106 (e.g., downstream of the SCR catalyst member 152, upstream of the injection housing 126, upstream of the turbine 116, etc.) to remove particulate matter, such as soot, from exhaust flowing in the exhaust conduit system 106.

While the vehicle system 100 has been shown and described in the context of use with a diesel internal combustion engine, it is understood that the vehicle system 100 may be used with other internal combustion engines, such as gasoline internal combustion engines, hybrid internal combustion engines, propane internal combustion engines, and other similar internal combustion engines.

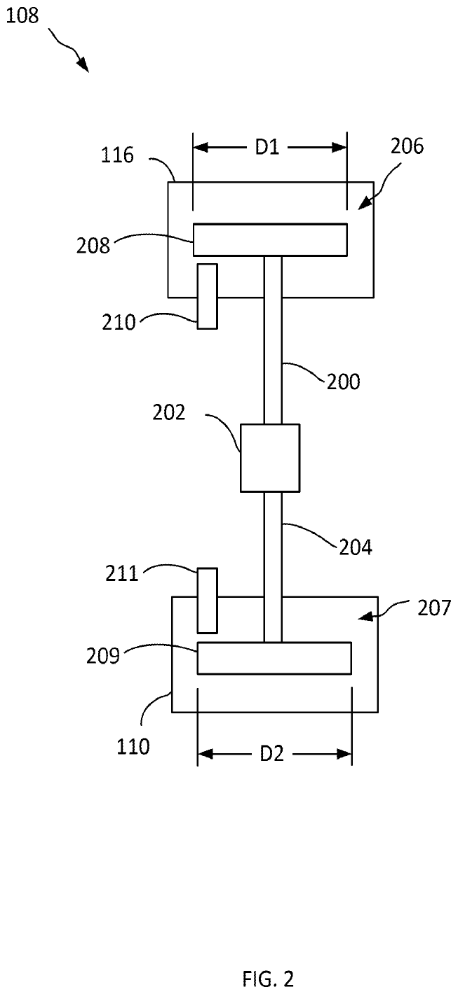

FIG. 2 illustrates the turbocharger 108 in greater detail. The turbocharger 108 further includes a turbine shaft 200 (e.g., shaft) coupled to the turbine 116 and configured to rotate. The turbocharger 108 further includes a motor 202 (e.g., electric motor, direct current motor, brushless motor, etc.) coupled to the turbine shaft 200. The motor 202 is electrically or communicatively coupled to the reductant delivery system controller 142. The reductant delivery system controller 142 may be configured to cause the motor 202 to rotate the turbine shaft 200. The turbocharger 108 further includes a compressor shaft 204 coupled to the compressor 110 and configured to rotate. The compressor shaft 204 may be coupled to the motor 202. The compressor shaft 204 may be coupled to the turbine shaft 200, such that the compressor shaft 204 and the turbine shaft 200 are rotationally fixed relative to each other. However, as discussed in more detail below, the turbocharger 108 may be configured such that the turbine shaft 200 and the compressor shaft 204 are not rotationally fixed relative to each other and such that rotation of the turbine shaft 200 relative to the compressor shaft 204 and rotation of the compressor shaft 204 relative to the turbine shaft 200 is facilitated.

As illustrated in FIG. 2, the turbine 116 includes an inner portion 206 and a turbine wheel 208 configured to be received at least partially within the inner portion 206 of the turbine 116. The turbine wheel 208 is coupled to the turbine shaft 200 and configured to rotate with the turbine shaft 200. The turbine 116 further includes a turbine sensor 210 configured to be received at least partially within the inner portion 206 and provide turbine signals associated with rotational speeds of the turbine wheel 208. The turbine sensor 210 is electrically or communicatively coupled to the reductant delivery system controller 142. The reductant delivery system controller 142 is configured to receive the turbine signals from the turbine sensor 210. The reductant delivery system controller 142 is configured to determine rotational speeds of the turbine wheel 208 based on the turbine signals. The reductant delivery system controller 142 may determine how much swirling there is in the exhaust based on the rotational speed of the turbine wheel 208.

In some embodiments, the turbine wheel 208 includes a rotating hub and a plurality of vanes (e.g., guides, blades, etc.) coupled to the rotating hub. The vanes may be shaped so as to cause the exhaust to swirl, or enhance the swirl of the exhaust, as the exhaust flows out of the turbine 116 and into the exhaust conduit system 106. In some embodiments, the turbocharger 108 is a variable geometry turbocharger. In these embodiments, the turbocharger 108 is electrically or communicatively coupled to the reductant delivery system controller 142 and the reductant delivery system controller 142 is configured to cause a geometry of the turbocharger 108 to change. The geometry may be an arrangement of the vanes on the turbine wheel 208, for example. By changing the geometry, an output of the turbocharger 108 may be varied by the reductant delivery system controller 142.

As illustrated in FIG. 2, the compressor 110 includes an inner portion 207 and a compressor wheel 209 configured to be received at least partially within the inner portion 207 of the compressor 110. The compressor wheel 209 is coupled to the compressor shaft 204 and configured to rotate with the compressor shaft 204. The compressor 110 further includes a compressor sensor 211 configured to be received at least partially within the inner portion 207 and provide compressor signals associated with rotational speeds of the compressor wheel 209. The compressor sensor 211 is electrically or communicatively coupled to the reductant delivery system controller 142. The reductant delivery system controller 142 is configured to receive the compressor signals from the compressor sensor 211. The reductant delivery system controller 142 is configured to determine rotational speeds of the compressor wheel 209 based on the compressor signals.

In some embodiments, the compressor wheel 209 includes a rotating hub and a plurality of vanes (e.g., guides, blades, etc.) coupled to the rotating hub. The vanes may be shaped so as to enhance the compression of the air as the air flows in and out of the compressor 110 and into the internal combustion engine 104 via the engine-compressor air conduit 112. In some embodiments, the turbocharger 108 is the variable geometry turbocharger. In these embodiments, the turbocharger 108 is electrically or communicatively coupled to the reductant delivery system controller 142 and the reductant delivery system controller 142 is configured to cause the geometry of the turbocharger 108 to change. The geometry may be an arrangement of the vanes on the compressor wheel 209, for example. By changing the geometry, an output of the turbocharger 108 may be varied by the reductant delivery system controller 142.

In some embodiments, as illustrated in FIG. 1, the compressor shaft 204 is coupled to the motor 202. The reductant delivery system controller 142 causes the motor 202 to rotate the compressor wheel 209 via the compressor shaft 204, which causes the compressor 110 to compress air into the internal combustion engine 104 via the engine-compressor air conduit 112. The compression provided by the motor 202 is in addition to the compression provided by the exhaust, which also causes rotation of the compressor wheel 209 via the turbine wheel 208. As the internal combustion engine 104 receives more air in the form of compressed air from the compressor 110, the internal combustion engine 104 burns more fuel. This results in high-temperature exhaust being released by the internal combustion engine 104 at the engine-turbine exhaust conduit 117. In these embodiments, the bypass valve 124 is configured at the first position, such that flow of the exhaust is facilitated from the bypass inlet conduit 120 to the bypass outlet conduit 122. These embodiments allow the internal combustion engine 104 to generate a constant power output or an increased power output, via the reductant delivery system controller 142 causing the motor 202 to rotate the compressor wheel 209 via the compressor shaft 204, while providing high-temperature exhaust to the exhaust conduit system 106, via the bypass valve 124 configured at the first position. The high-temperature exhaust may allow the SCR catalyst member 152 to transition from the ambient temperature to the operating temperature quickly. Additionally, the high-temperature exhaust may improve mixing between the exhaust and the treatment fluid and mitigate deposit accumulation (e.g., collection, etc.) in the exhaust conduit system 106.

At a peak (e.g., maximum, etc.) efficiency of the turbocharger 108, the exhaust flowing out of the turbine 116 into the turbine-housing exhaust conduit 123 may be mostly axial (e.g., laminar, non-turbulent, etc.). Because there is little swirl in such exhaust outflow, mixing of reductant into the exhaust is minimal. Typically, peak efficiency of the turbocharger 108 occurs when a rotational speed (e.g., a first rotational speed) of the turbine wheel 208 is set by a flow rate of the exhaust. In order to increase mixing, the reductant delivery system controller 142 causes the motor 202 to rotate the turbine wheel 208 via the turbine shaft 200 at a different rotational speed (e.g., a second rotational speed), where the turbocharger 108 is not at peak efficiency (e.g., the turbocharger 108 is off-peak, etc.) and the exhaust flowing out of the turbine 116 into the turbine-housing exhaust conduit 123 is less axial (e.g., more turbulent, includes more swirling, etc.). Therefore, the vehicle system 100 operates differently than conventional systems in that the turbocharger 108 is intentionally operated, at least during certain times, at less than peak efficiency in order to generate swirl which is used to facilitate mixing of the exhaust and the treatment fluid. This approach is counterintuitive because conventional systems typically seek to operate at peak efficiency and perform mixing, if at all, using other mechanisms. This causes the compressor wheel 209 and the compressor shaft 204 to rotate as the turbine shaft 200 and the turbine wheel 208 rotate via the motor 202. This results in the compressor 110 providing more compressed air to the internal combustion engine 104, changing the air-fuel ratio within the internal combustion engine 104. This may not be desirable depending on a power demand of the internal combustion engine 104.

The turbine sensor 210 may be configured to provide a turbine signal (e.g., a first turbine signal) associated with the first rotational speed of the turbine wheel 208. The reductant delivery system controller 142 may receive the first turbine signal from the turbine sensor 210 and determine the first rotational speed of the turbine wheel 208 based on the first turbine signal. The reductant delivery system controller 142 may also receive an exhaust signal (e.g., a first exhaust signal) from the exhaust sensor 154 and determine a UI (e.g., a first UI) based on the first exhaust signal. The reductant delivery system controller 142 may determine the second rotational speed of the turbine wheel 208 based on the first rotational speed and the first UI and cause the motor 202 to rotate the turbine wheel 208 via the turbine shaft 200 at the second rotational speed. The reductant delivery system controller 142 may receive another exhaust signal (e.g., a second exhaust signal) from the exhaust sensor 154 and determine a UI (e.g., a second UI) based on the second exhaust signal, where the second UI is equal to or greater than the first UI.

The reductant delivery system controller 142 may determine a power output (e.g., a first power output) of the turbine 116 based on the first rotational speed of the turbine wheel 208 and determine a turbine efficiency (e.g., a first turbine efficiency) based on the first power output. The reductant delivery system controller 142 may also determine a power output (e.g., a second power output) based on the second rotational speed of the turbine wheel 208 and determine a turbine efficiency (e.g., a second turbine efficiency) based on the second power output, where the second turbine efficiency is equal to or less than the first turbine efficiency.

Additionally, the reductant delivery system controller 142 may cause the motor 202 to rotate the turbine wheel 208 via the turbine shaft 200 at a different rotational speed in order to reduce a power output of the internal combustion engine 104 (e.g., active exhaust breaking, etc.). The reductant delivery system controller 142 may receive a turbine signal (e.g., a first turbine signal) from the turbine sensor, determine a rotational speed (e.g., a first rotational speed) of the turbine wheel 208 based on the first turbine signal, determine a rotational speed (e.g., second rotational speed) of the turbine wheel 208 based on the first rotational speed of the turbine wheel 208, and cause the motor 202 to rotate the turbine wheel 208 at the second rotational speed, where the second rotational speed is equal to or less than the first rotational speed.

The embodiments below provide additional configurations to alleviate the result of changing the air-fuel ratio within the internal combustion engine 104 when the compressor shaft 204 is coupled to the turbine shaft 200. It is to be understood that the embodiments below may be combined with other embodiments disclosed herein.

The internal combustion engine 104 may include cylinder-piston assemblies. Each of the cylinder-piston assemblies includes a cylinder and a piston configured to be received within the cylinder. Each of the cylinder-piston assemblies is configured to facilitate an intake stroke, a compression stroke, a combustion stroke, and an exhaust stroke of the internal combustion engine 104. At the intake stroke, the cylinder is configured to intake air and fuel. At the compression stroke, the piston is configured to compress the air and fuel within the cylinder. At the combustion stroke, the air and fuel are ignited (e.g., combusted, etc.). At the exhaust stroke, the burnt fuel as well as partial unburnt fuel (e.g., fuel) and air exit the cylinder-piston assembly.

The vehicle system 100 may include a fuel pump and fuel injectors fluidly coupled to the fuel pump. Each of the fuel injectors is configured to inject fuel from the fuel pump into one cylinder of the cylinder-piston assemblies. The fuel injectors are electrically or communicatively coupled to the reductant delivery system controller 142 or the central controller 150. The reductant delivery system controller 142 or the central controller 150 may be configured to control fuel amounts injected by the fuel injectors. The reductant delivery system controller 142 or the central controller 150 may cause the fuel injectors to inject a fuel amount into the cylinders corresponding to a pressure of the air provided by the compressor 110 to the internal combustion engine 104 via the engine-compressor air conduit 112. This allows the internal combustion engine 104 to maintain a target air-fuel ratio.

The exhaust system 102 may include a recirculation conduit coupled to the engine-turbine exhaust conduit 117 and the internal combustion engine 104. The recirculation conduit facilitates exhaust flow from the engine-turbine exhaust conduit 117 to the internal combustion engine 104, such that the exhaust is recirculated into the internal combustion engine 104 (e.g., exhaust gas recirculation (EGR)). In this configuration, the EGR may be reduced to allow the internal combustion engine 104 to take in (e.g., handle) more air from the compressor 110 via the engine-compressor air conduit 112.

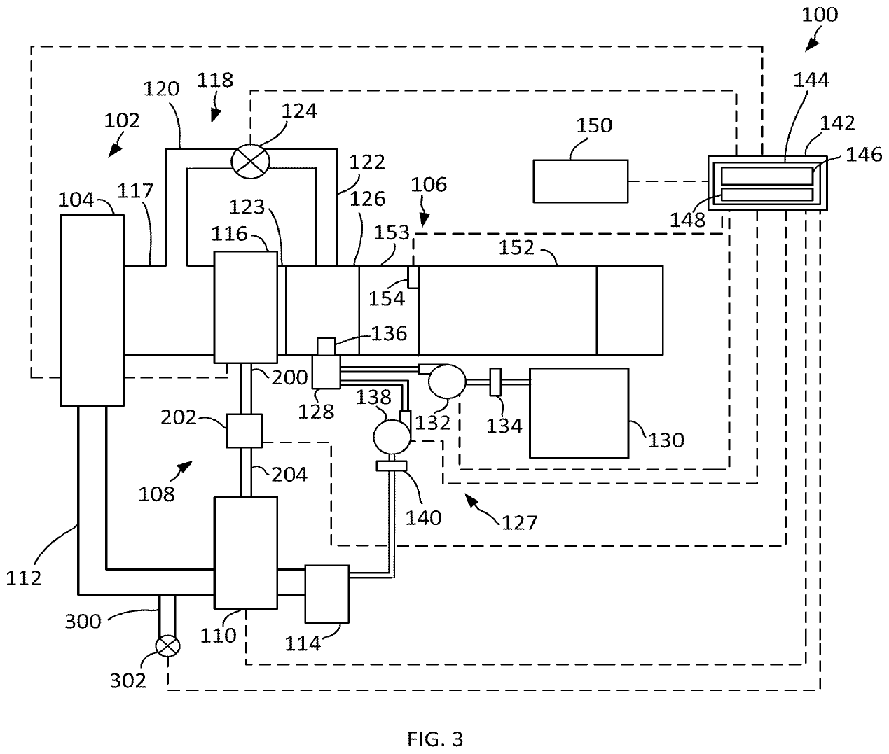

As illustrated in FIG. 3, the exhaust system 102 may include a valve conduit 300 and a blowoff valve 302 coupled to the valve conduit 300. The valve conduit 300 is disposed downstream of the compressor 110 and upstream of the engine-compressor air conduit 112. The valve conduit 300 is configured to receive at least a portion of the air from the compressor 110. The blowoff valve 302 is operable at least between (i) a first position, where flow of the air from the compressor 110 to the engine-compressor air conduit 112 is facilitated (e.g., the blowoff valve 302 is closed), and (ii) a second position, where at least a portion of the flow of the air from the compressor 110 is released into the atmosphere (e.g., the blowoff valve 302 is open). The blowoff valve 302 is electrically or communicatively coupled to the reductant delivery system controller 142. The reductant delivery system controller 142 may be configured to cause the blowoff valve 302 to operate between the first position and the second position. The reductant delivery system controller 142 may also be configured to cause the blowoff valve 302 to operate at a third position that is between the first position and the second position (e.g., the blowoff valve 302 is partially open). Based on a rotational speed of the compressor wheel 209, the reductant delivery system controller 142 causes the blowoff valve 302 to operate at a target position (e.g., the first position, the second position, or the third position). This reduces amount of air delivered to the internal combustion engine 104 via the engine-compressor air conduit 112, allowing the internal combustion engine 104 to maintain the target air-fuel ratio.

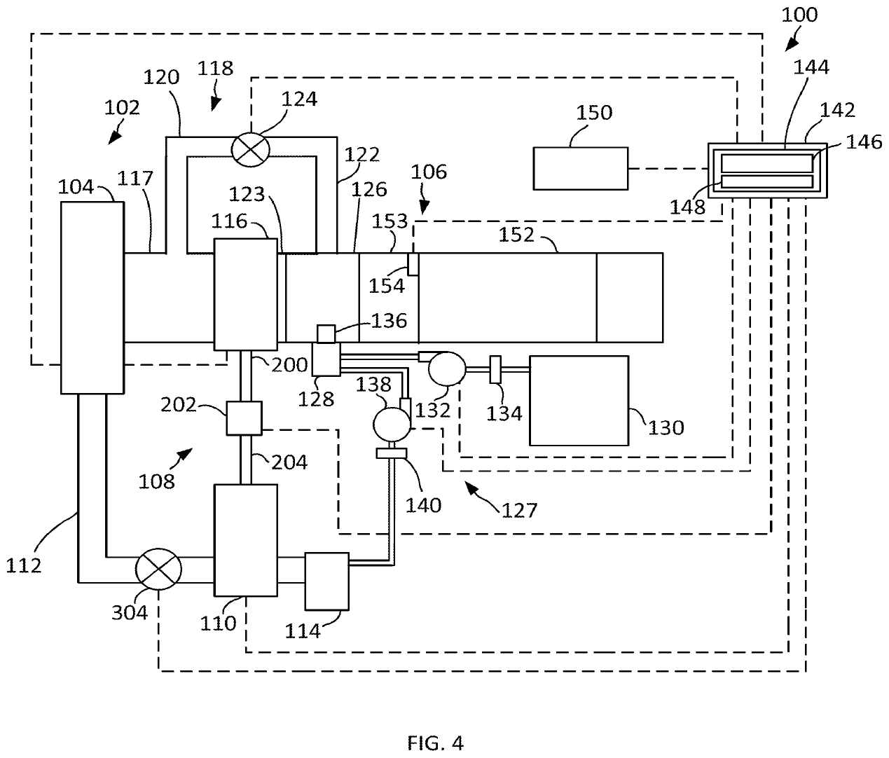

As illustrated in FIG. 4, the exhaust system 102 may include an intake air throttle (e.g., IAT) valve 304. The IAT valve 304 may be disposed downstream of the compressor 110 and upstream of the engine-compressor air conduit 112. The IAT valve 304 is operable at least between (i) a first position, where flow of the air from the compressor 110 to the engine-compressor air conduit 112 is facilitated (e.g., the IAT valve 304 is open), and (ii) a second position, where flow of the air from the compressor 110 to the engine-compressor air conduit 112 is prohibited (e.g., the IAT valve 304 is closed). The IAT valve 304 is configured to throttle (e.g., intermittently allow, etc.) flow of the air from the compressor 110 to the engine-compressor air conduit 112. The IAT valve 304 is electrically or communicatively coupled to the reductant delivery system controller 142. The reductant delivery system controller 142 may be configured to cause the IAT valve 304 to operate between the first position and the second position. The reductant delivery system controller 142 may also be configured to cause the IAT valve 304 to operate at a third position that is between the first position and the second position (e.g., the IAT valve 304 is partially open). Based on the rotational speed of the compressor wheel 209, the reductant delivery system controller 142 causes the IAT valve 304 to operate at a target position (e.g., the first position, the second position, or the third position). This reduces amount of air delivered to the internal combustion engine 104 via the engine-compressor air conduit 112, allowing the internal combustion engine 104 to maintain the target air-fuel ratio.

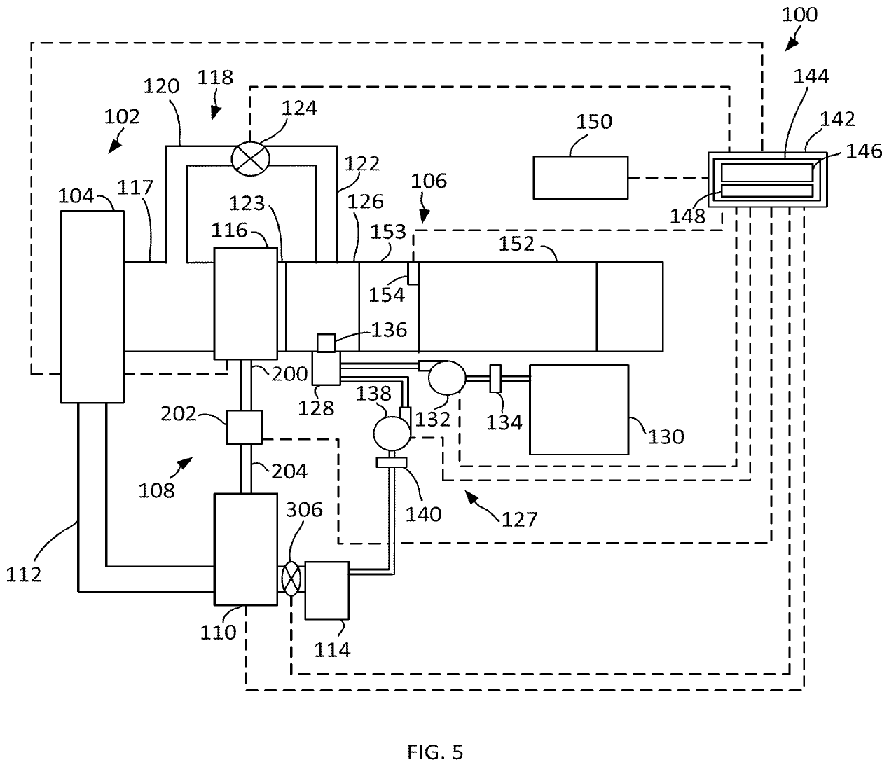

As illustrated in FIG. 5, the exhaust system 102 may include an IAT valve 306. The IAT valve 306 may be disposed downstream of the air source 114 and upstream of the compressor 110. The IAT valve 306 is operable at least between (i) a first position, where flow of the air from the air source 114 to the compressor 110 is facilitated (e.g., the IAT valve 306 is open), and (ii) a second position, the flow of the air from the air source 114 to the compressor 110 is prohibited (e.g., the IAT valve 306 is closed). The IAT valve 306 is configured to throttle flow of the air from the air source 114 to the compressor 110. The IAT valve 306 is electrically or communicatively coupled to the reductant delivery system controller 142. The reductant delivery system controller 142 may be configured to cause the IAT valve 306 to operate between the first position and the second position. The reductant delivery system controller 142 may also be configured to cause the IAT valve 306 to operate at a third position that is between the first position and the second position (e.g., the IAT valve 306 is partially open). Based on the rotational speed of the compressor wheel 209, the reductant delivery system controller 142 causes the IAT valve 306 to operate at a target position (e.g., the first position, the second position, or the third position). This reduces amount of air delivered to the internal combustion engine 104 via the engine-compressor air conduit 112, allowing the internal combustion engine 104 to maintain the target air-fuel ratio.

The exhaust system 102 may include a cooler (e.g., charge air cooler, chiller, cooling fan and shroud, coolant supply, etc.) disposed downstream of the compressor 110 and upstream of the engine-compressor air conduit 112. The cooler is configured to change the pressure of the air from the compressor 110 by lowering its temperature (e.g., cooling the air from the compressor 110). In this way, the air provided to the internal combustion engine of the vehicle system 100 may be cooled which can increase an efficiency of and/or power produced by the internal combustion engine.

The cooler is electrically or communicatively coupled to the reductant delivery system controller 142. The reductant delivery system controller 142 may be configured to cause the cooler to operate at a target temperature. Based on the rotational speed of the compressor wheel 209, the reductant delivery system controller 142 causes the cooler to operate at the target temperature. The target temperature may correspond to a reduced cooling configuration of the cooler, such that the target temperature of the cooler is equal to or approximately equal to a temperature of the air exiting the compressor 110. This can reduce an amount of air delivered to the internal combustion engine 104 via the engine-compressor air conduit 112, allowing the internal combustion engine 104 to maintain the target air-fuel ratio.

The turbine wheel 208 includes a turbine wheel diameter D1 and the compressor wheel 209 includes a compressor wheel diameter D2. Typically, a power requirement of the compressor 110 is determined based on a target power output of the internal combustion engine 104. The power requirement of the compressor 110 corresponds to the compressor wheel diameter D2 and is configured to be met by a power generation of the turbine 116. The power generation of the turbine 116 corresponds to the turbine wheel diameter D1. As a result, the turbine wheel diameter D1 is matched to the compressor wheel diameter D2. In these embodiments, the compressor wheel diameter D2 may be configured at a smaller value than a value corresponding to the target power output of the internal combustion engine 104. This counteracts the result of the compressor 110 providing more compressed air to the internal combustion engine 104, allowing the internal combustion engine 104 to operate at the target air-fuel ratio.

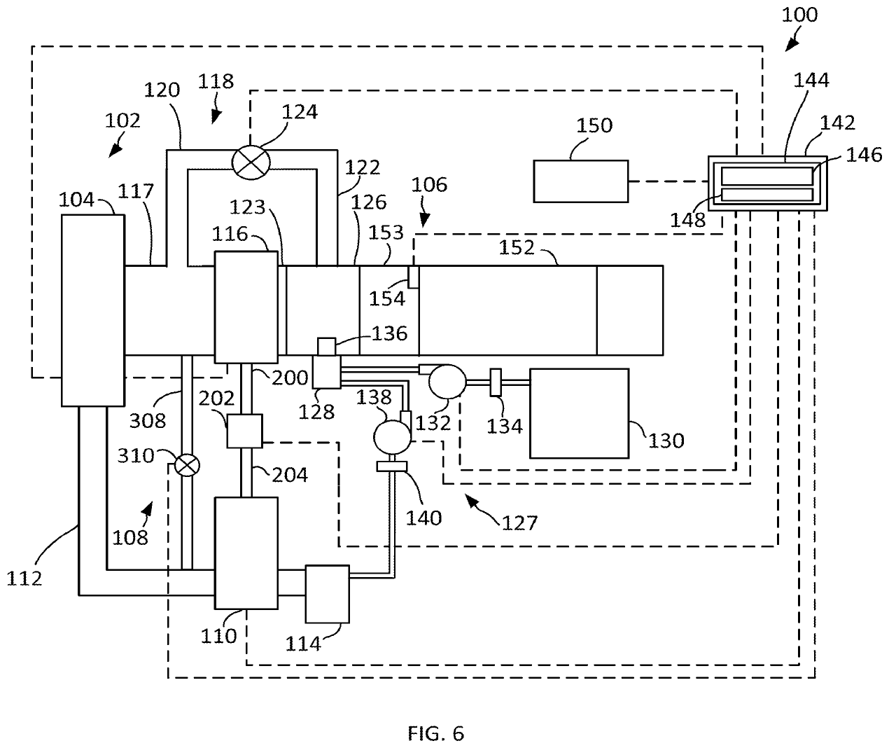

As illustrated in FIG. 6, the exhaust system 102 may include a compressor-turbine air conduit 308 coupled to the engine-compressor air conduit 112 and the engine-turbine exhaust conduit 117. The compressor-turbine air conduit 308 facilitates air flow from the engine-compressor air conduit 112 to engine-turbine exhaust conduit 117, such that at least a portion of the air from the compressor 110 is received by the turbine 116. The exhaust system 102 may also include a bypass valve 310 disposed within the compressor-turbine air conduit 308. The bypass valve 310 is operable at least between (i) a first position, where flow of the air through compressor-turbine air conduit 308 is facilitated (e.g., the bypass valve 310 is open), and (ii) a second position, where flow of the air through compressor-turbine air conduit 308 is prohibited (e.g., the bypass valve 310 is closed). The bypass valve 310 is electrically or communicatively coupled to the reductant delivery system controller 142. The reductant delivery system controller 142 may be configured to cause the bypass valve 310 to operate between the first position and the second position. The reductant delivery system controller 142 may also be configured to cause the bypass valve 310 to operate at a third position that is between the first position and the second position (e.g., the bypass valve 310 is partially open). Based on a rotational speed of the compressor wheel 209, the reductant delivery system controller 142 causes the bypass valve 310 to operate at a target position (e.g., the first position, the second position, or the third position). This reduces amount of air delivered to the internal combustion engine 104 via the engine-compressor air conduit 112, allowing the internal combustion engine 104 to maintain the target air-fuel ratio. This also increases amount of fluid (e.g., exhaust, air, exhaust and air mixture, etc.) in the engine-turbine exhaust conduit 117, providing the turbine 116 with more fluid, thereby increasing the rotational speed of the turbine wheel 208. This can reduce an amount of power required by the motor 202 to rotate the turbine shaft 200, which reduces energy consumption of the vehicle system 100.

The embodiments above provided configurations to alleviate the result of changing the air-fuel ratio within the internal combustion engine 104 when the compressor shaft 204 is coupled to the turbine shaft 200. The embodiments below provide additional configuration to alleviate the result of changing the air-fuel ratio within the internal combustion engine 104 when the compressor shaft 204 is not coupled (e.g., decoupled, etc.) to the turbine shaft 200. It is to be understood that the embodiments below may be combined with other embodiments disclosed herein.

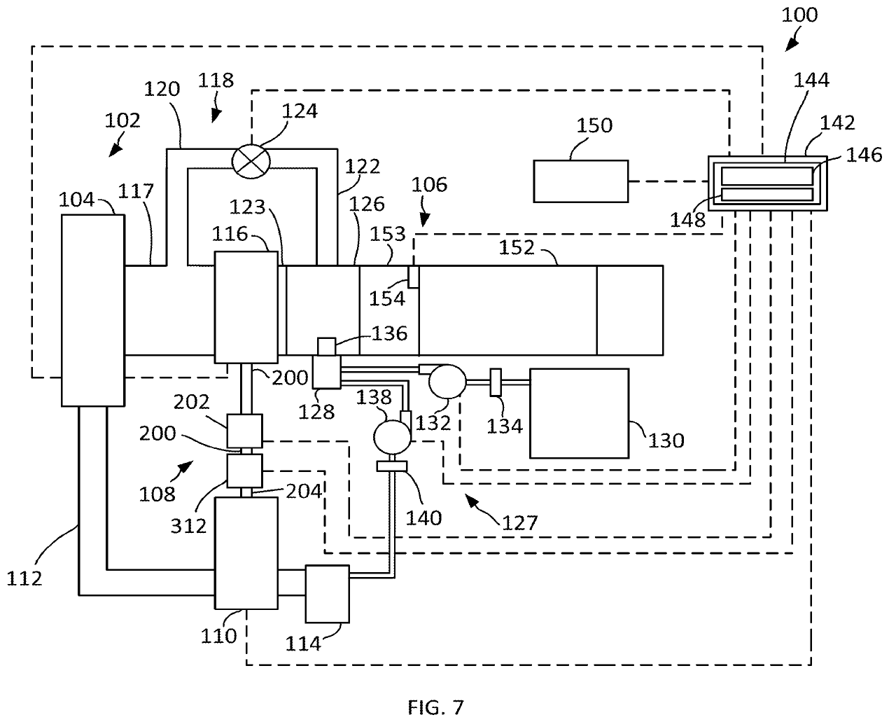

As illustrated in FIG. 7, the turbocharger 108 may include an actuator 312 coupled to the turbine shaft 200 and the compressor shaft 204. The actuator 312 facilitates engagement (e.g., attaching, coupling, etc.) and disengagement (e.g., detaching, decoupling etc.) of the turbine shaft 200 to the compressor shaft 204. The actuator 312 is electrically or communicatively coupled to the reductant delivery system controller 142. The reductant delivery system controller 142 may be configured to cause the actuator 312 to couple or uncouple the turbine shaft 200 to the compressor shaft 204.

The actuator 312 may be a friction coupler (e.g., an automotive clutch, etc.). The actuator 312 may utilize friction to engage the turbine shaft 200 to the compressor shaft 204, where an interface of the turbine shaft 200 is in contact with an interface of the compressor shaft 204 via friction. The actuator 312 may also be a viscous coupler (e.g., a transmission torque converter, etc.). The actuator 312 may utilize a viscous (e.g., sticky, thick, etc.) fluid to engage the turbine shaft 200 to the compressor shaft 204. The actuator 312 may also be a solid coupler (e.g., keyway coupling, castle nut assembly, Spartan locker, etc.) and include a turbine portion and a compressor portion. In some embodiments, the turbine portion is attached to the turbine shaft 200 and the compressor portion selectively attaches to and detaches from the compressor shaft 204. In other embodiments, the compressor portion is attached to the compressor shaft 204 and the turbine portion selectively attaches to and detaches from the turbine shaft 200.

The actuator 312 may include an electronic solenoid assembly configured to selectively engage and disengage the turbine shaft 200 to the compressor shaft 204. The electronic solenoid assembly is operable at least between (i) a first position, where the turbine shaft 200 is engaged to the compressor shaft 204 (e.g., the electronic solenoid assembly is extended), and (ii) a second position, where the turbine shaft 200 is disengaged from the compressor shaft 204 (e.g., the electronic solenoid assembly is retracted). The reductant delivery system controller 142 may be configured to cause the electronic solenoid assembly to operate between the first position and the second position.

The actuator 312 may include an attaching body configured to operate pneumatically or hydraulically. Pressurized fluid (e.g., air source 114, reductant source 130, engine oil, vehicle hydraulic fluid, DEF, etc.) may be used to operate the attaching body. The attaching body may be operable at least between (i) a first position, where the turbine shaft 200 is engaged to the compressor shaft 204 (e.g., the attaching body is extended), and (ii) a second position, where the turbine shaft 200 is disengaged from the compressor shaft 204 (e.g., the attaching body is retracted). The reductant delivery system controller 142 may be configured to cause the attaching body to operate between the first position and the second position via the pressurized fluid.

The actuator 312 may include electromagnets configured, via electrical current, to (i) attract the turbine shaft 200 and the compressor shaft 204 and (ii) engage and disengage the turbine shaft 200 to the compressor shaft 204. The electromagnets may be operable at least between (i) a first position, where the electromagnets (a) attract the turbine shaft 200 and the compressor shaft 204 and (b) engage the turbine shaft 200 to the compressor shaft 204 (e.g., the electromagnets are on), and (ii) a second position, where the electromagnets (a) do not attract the turbine shaft 200 and the compressor shaft 204 and (b) do not engage or disengage the turbine shaft 200 to the compressor shaft 204 (e.g., the electromagnets are off). The reductant delivery system controller 142 may be configured to cause the electromagnets to operate between the first position and the second position via electrical current.

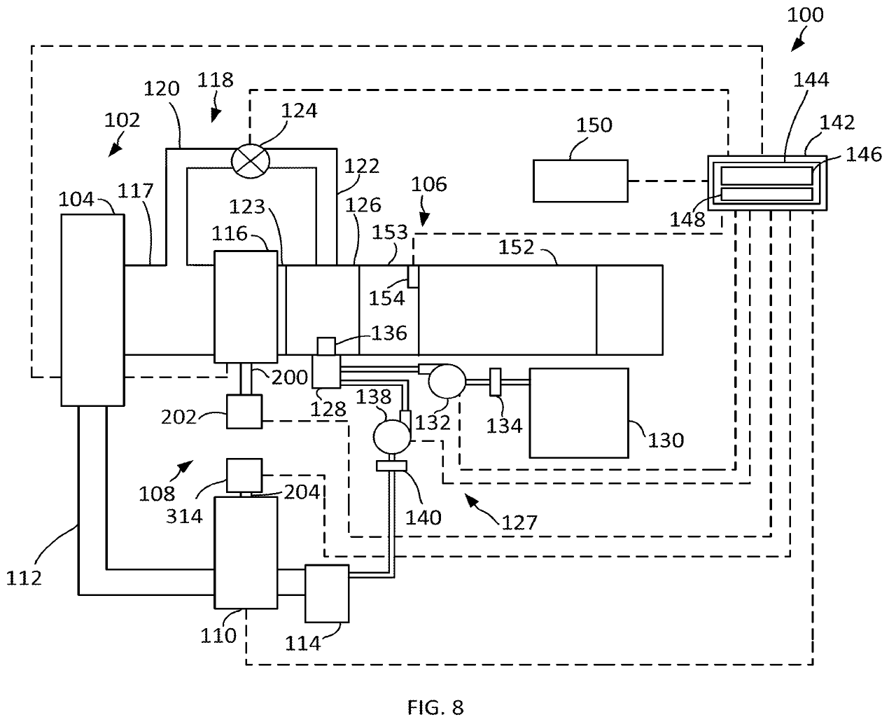

As illustrated in FIG. 8, the turbocharger 108 may include a motor 314 (e.g., second motor, compressor motor, etc.) coupled to the compressor shaft 204. The motor 314 is electrically or communicatively coupled to the reductant delivery system controller 142. The reductant delivery system controller 142 may be configured to cause the motor 314 to rotate the compressor wheel 209 via the compressor shaft 204. The motor 314 allows for rotation of the compressor wheel 209 to be controlled independently of the turbine shaft 200. The reductant delivery system controller 142 may cause the motor 202 to rotate the turbine wheel 208 at a turbine rotational speed via the turbine shaft 200 to increase swirling in the exhaust. Concurrently, the reductant delivery system controller 142 may cause the motor 314 to rotate the compressor wheel 209 at a compressor rotational speed to provide the target air-fuel ratio within the internal combustion engine 104. In some embodiments, the turbine rotational speed is higher than the compressor rotational speed. In other embodiments, the turbine rotational speed is (i) equal to the compressor rotational speed or (ii) less than the compressor rotational speed. In some embodiments, the turbine 116, the turbine shaft 200, and the motor 202 are located in different portions (e.g., compartments, sections, etc.) of the vehicle system 100 than the compressor 110, the compressor shaft 204, and the motor 314.

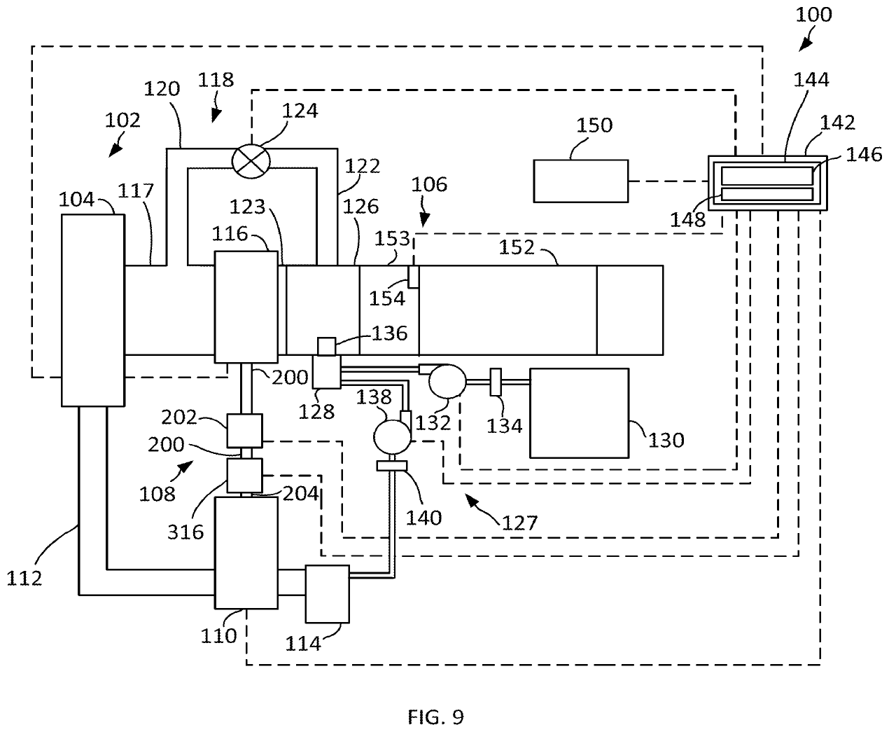

As illustrated in FIG. 9, the turbocharger 108 may include a gearbox 316 (e.g., transmission, gear train, etc.) coupled to the turbine shaft 200 and the compressor shaft 204. The gearbox 316 includes a plurality of gears. Each of the gears is configured to set the gearbox 316 to a target gear ratio, where the turbine rotational speed is equal to the compressor rotational speed at a gear ratio of 1:1. The gearbox 316 is electrically or communicatively coupled to the reductant delivery system controller 142. The reductant delivery system controller 142 may be configured to cause the gearbox 316 to select a gear based on the turbine rotational speed. This allows the reductant delivery system controller 142 to (i) cause the motor 202 to rotate the turbine wheel 208 at a turbine rotational speed via the turbine shaft 200 to increase swirling in the exhaust, and (ii) cause the gearbox 316 to select a gear that rotates the compressor wheel 209 via the compressor shaft 204 at a compressor rotational speed associated with the target air-fuel ratio for the internal combustion engine 104. In some embodiments, the turbine rotational speed is equal to the compressor rotational speed at a first gear ratio, the turbine rotational speed is higher than the compressor rotational speed at a second gear ratio, and the turbine rotational speed is less than the compressor rotational speed at a third gear ratio.

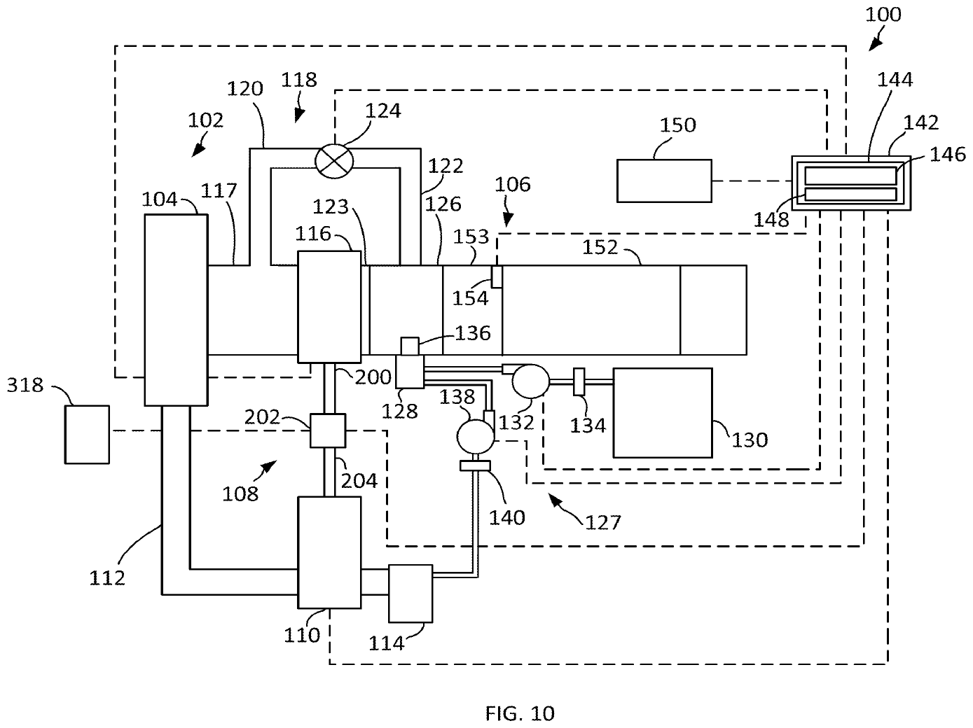

As illustrated in FIGS. 10-12 and 14-16, the motor 202 is operable between a driving mode and a driven mode. In the driving mode, the motor 202 is configured to rotate the turbine shaft 200. In the driven mode, the motor 202 is configured to function as a generator by producing electricity using rotation of the turbine shaft 200. The reductant delivery system controller 142 may be configured to cause the motor 202 to operate between the driving mode and the driven mode. In the driven mode, the motor 202 reduces the turbine rotational speed via electric loading, resulting in increased swirling in the exhaust. The embodiments below provide additional configurations when the compressor shaft 204 is coupled to the turbine shaft 200. It is to be understood that the embodiments below may be combined with other embodiments disclosed herein.

As illustrated in FIG. 10, the vehicle system 100 may include an electrical load 318 (e.g., battery, fuel cell, an electrical supply to the air pump 138, an electrical supply to the reductant pump 132, an electrical supply to the dosing module 128, etc.). The electrical load 318 may be electrically or communicatively coupled to the motor 202, such that the electrical load 318 is configured to receive the energy generated by the motor 202. The energy in the electrical load 318 may be used to charge a vehicle battery, power an exhaust electrical heater, power an electrical heater for an exhaust-treatment fluid mixer, etc.

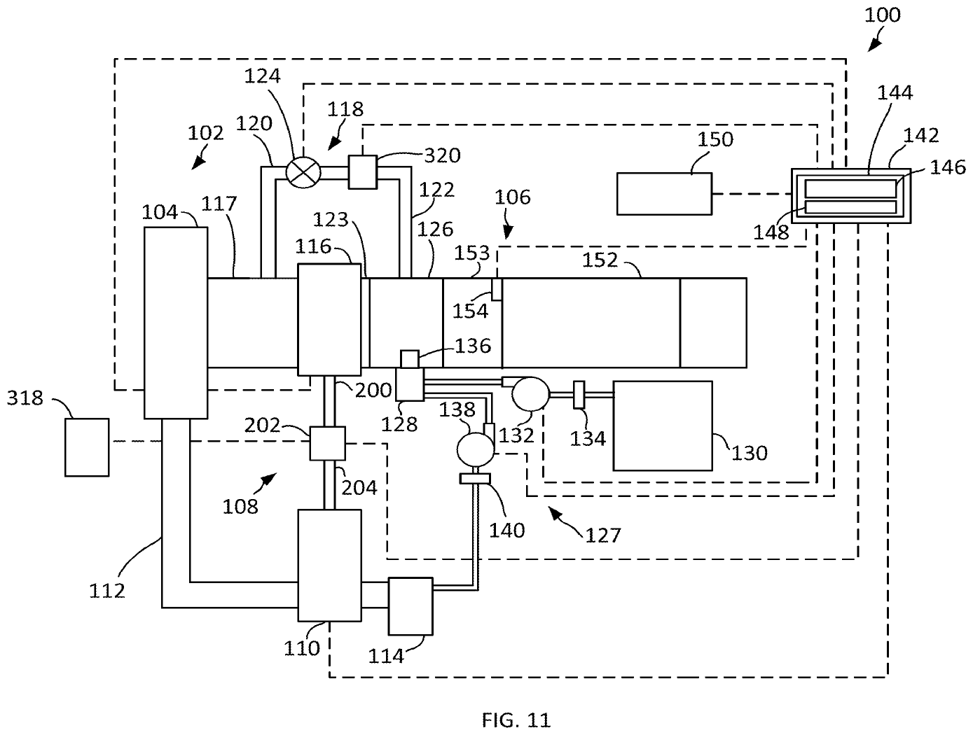

As illustrated in FIG. 11, the bypass system 118 may include a heater 320 (e.g., grid gas heater, resistance heater, electrical heater, etc.) disposed downstream of the bypass valve 124 and upstream of the bypass outlet conduit 122. The heater 320 is configured to increase a temperature of the exhaust. The heater 320 is electrically or communicatively coupled to the reductant delivery system controller 142. The reductant delivery system controller 142 may be configured to cause the heater 320 to operate at a target temperature. Based on a UI from an exhaust signal via the exhaust sensor 154, the reductant delivery system controller 142 causes the heater 320 to operate at a target temperature. Increasing the temperature of the exhaust may allow the SCR catalyst member 152 to transition from the ambient temperature to the operating temperature quickly. Additionally, increasing the temperature of the exhaust may improve mixing between the exhaust and the treatment fluid and mitigate deposit accumulation in the exhaust conduit system 106. The heater 320 may be electrically or communicatively coupled to the electrical load 318 or to the motor 202, such that the heater 320 receives energy generated by the motor 202.

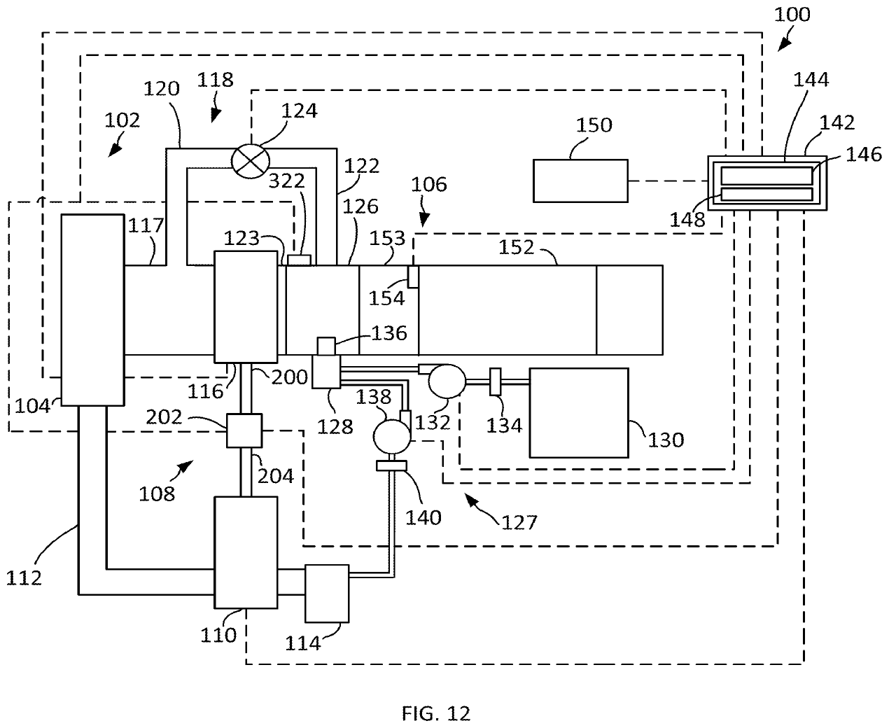

As illustrated in FIG. 12, the exhaust system 102 may include a heater 322 (e.g., surface heater, resistance heater, electrical heater, etc.) disposed around at least a portion of the injection housing 126. The heater 322 is configured to increase temperatures of the exhaust and the treatment fluid within the injection housing 126. The heater 322 is electrically or communicatively coupled to the reductant delivery system controller 142. The reductant delivery system controller 142 may be configured to cause the heater 322 to operate at a target temperature. Based on a uniformity index from an exhaust signal via the exhaust sensor 154, the reductant delivery system controller 142 causes the heater 322 to operate at a target temperature. Increasing the temperature of the exhaust may allow the SCR catalyst member 152 to transition from the ambient temperature to the operating temperature quickly and improve mixing between the exhaust and the treatment fluid. Due to injection of the treatment fluid taking place in the injection housing 126 via the injector 136, the injection housing 126 may be most prone to accumulating deposits of treatment fluid along its surfaces (e.g., primary impingement zone, etc.). Increasing the temperature of the exhaust via the heater 322 may mitigate deposit accumulation in the injection housing 126 and the exhaust conduit system 106. The heater 322 may be electrically or communicatively coupled to the electrical load 318 or to the motor 202, such that the heater 320 receives energy generated by the motor 202.

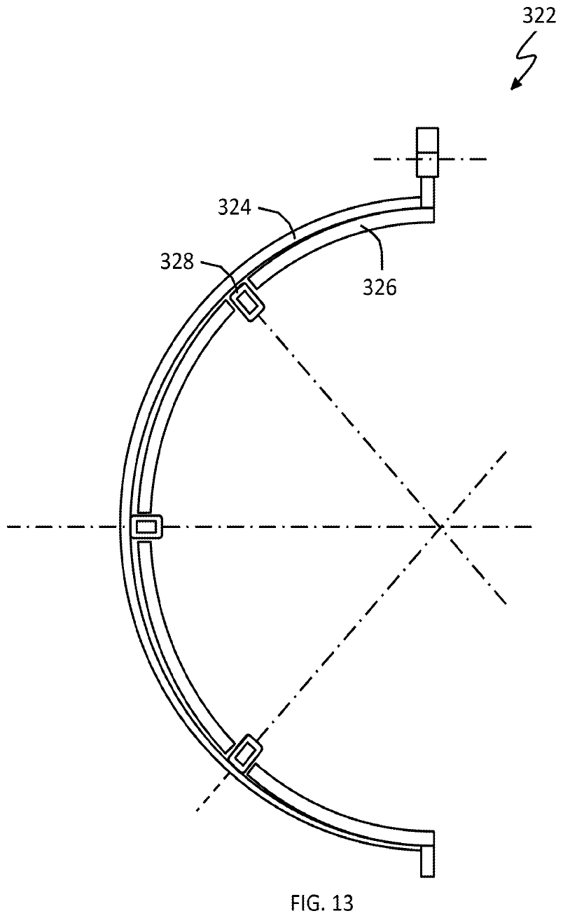

As illustrated in FIG. 13, the heater 322 described above may include a cover 324, a plurality of heating elements 326, and a plurality of spacers 328 (e.g., wedges, etc.). The cover 324 is coupled to outer portions of the heating elements 326 and outer portions of the spacers 328. The cover 324 is configured to protect the heating elements 326 and the spacers 328. The cover 324 is further configured to insulate heat generated within the heater 322 and encourage heat flow towards the exhaust and treatment fluid within the injection housing 126. Each of the heating elements 326 is coupled to an inner portion of the cover 324 and to side portions of the spacers 328. Each of the heating elements 326 is configured to generate heat via energy (e.g., electrical current). Each of the spacers 328 is coupled to an inner portion of the cover 324 and to side portions of the heating elements 326. Each of the spacers 328 is configured to couple to the injection housing 126 and provide structural rigidity to the heater 322. In some embodiments, the cover 324 is a stainless steel can, the heating elements 326 includes cordierite plates and molybdenum, and the spacers 328 are made of (e.g., manufactured from, etc.) metal.

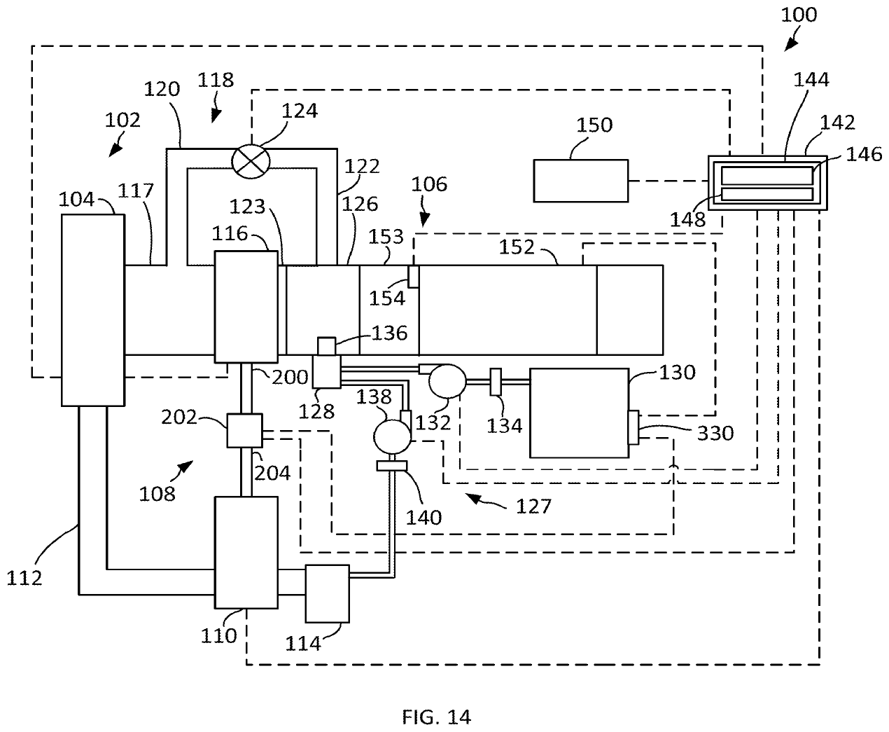

As illustrated in FIG. 14, the exhaust system 102 may include a heater 330 (e.g., surface heater, resistance heater, electric heater, etc.) disposed at least partially around the reductant source 130. The heater 330 is configured to increase a temperature of the reductant source 130, thereby increasing a temperature of the treatment fluid inside of the reductant source 130. The heater 330 is electrically or communicatively coupled to the reductant delivery system controller 142. The reductant delivery system controller 142 may be configured to cause the heater 330 to operate at a target temperature. Based on a UI from an exhaust signal via the exhaust sensor 154, the reductant delivery system controller 142 causes the heater 330 to operate at a target temperature. Increasing the temperature of the treatment fluid may allow the treatment fluid to decompose quicker when injected into the injection housing 126 via the injector 136, improving reduction of NOx emissions. Additionally, the treatment fluid may solidify (e.g., freeze, etc.) at cold temperatures or after being stagnate for long periods of time. Increasing the temperature of the treatment fluid may allow the treatment fluid to return to a target temperature where the treatment fluid is primarily in liquid form. The heater 330 may be electrically or communicatively coupled to the electrical load 318 or to the motor 202, such that the heater 330 receives energy generated by the motor 202.

While power generated by the motor 202 may be used to power the electrical load 318 and other components (e.g., heater 320, heater 322, heater 330, etc.), configuring the motor 202 in the driven mode and having the turbine shaft 200 coupled to the compressor shaft 204 affects the air provided by the compressor 110. Slowing down the turbine shaft 200 via the motor 202 results in the compressor 110 providing less air to the internal combustion engine 104, changing the air-fuel ratio within the internal combustion engine 104. This may not be desirable depending on the power demand of the internal combustion engine 104. The following embodiments provide configurations to alleviate this result when the compressor shaft 204 is not coupled (e.g., decoupled, etc.) to the turbine shaft 200. It is to be understood that the embodiments below may be combined with other embodiments disclosed herein.

The internal combustion engine 104 may include the cylinder-piston assemblies. The vehicle system 100 may include a fuel pump and fuel injectors fluidly coupled to the fuel pump. Each of the fuel injectors is configured to inject fuel from the fuel pump into one cylinder of the cylinder-piston assemblies. The fuel injectors are electrically or communicatively coupled to the reductant delivery system controller 142 or the central controller 150. The reductant delivery system controller 142 or the central controller 150 may be configured to control fuel amounts injected by the fuel injectors. The reductant delivery system controller 142 or the central controller 150 may cause the fuel injectors to inject the fuel amount into the cylinders corresponding to the pressure of the air provided by the compressor 110 to the internal combustion engine 104 via the engine-compressor air conduit 112. This allows the internal combustion engine 104 to maintain a target air-fuel ratio.

The exhaust system 102 may include the recirculation conduit coupled to the engine-turbine exhaust conduit 117 and the internal combustion engine 104. The recirculation conduit facilitates EGR. In this configuration, the EGR may be increased to allow the internal combustion engine 104 to take in more exhaust from the engine-turbine exhaust conduit 117 as compensation for a decreased amount of air.

The exhaust system 102 may include the cooler disposed downstream of the compressor 110 and upstream of the engine-compressor air conduit 112. The cooler is configured to change the pressure of the air from the compressor 110 by lowering its temperature. In this way, the air provided to the internal combustion engine of the vehicle system 100 may be cooled which can increase an efficiency of and/or power produced by the internal combustion engine.

The cooler is electrically or communicatively coupled to the reductant delivery system controller 142. The reductant delivery system controller 142 may be configured to cause the cooler to operate at a target temperature. Based on the rotational speed of the compressor wheel 209, the reductant delivery system controller 142 causes the cooler to operate at the target temperature. The target temperature may correspond to a normal or high cooling configuration of the cooler, such that the target temperature of the cooler is less than the temperature of the air exiting the compressor 110. This can decrease the pressure of the air from the compressor 110, thereby increasing an amount of air delivered to the internal combustion engine 104 via the engine-compressor air conduit 112 and allowing the internal combustion engine 104 to maintain the target air-fuel ratio.

The compressor wheel diameter D2 may be configured at a larger value than a value corresponding to the target power output of the internal combustion engine 104. This counteracts the result of the compressor 110 providing less compressed air to the internal combustion engine 104, allowing the internal combustion engine 104 to operate at the target air-fuel ratio.

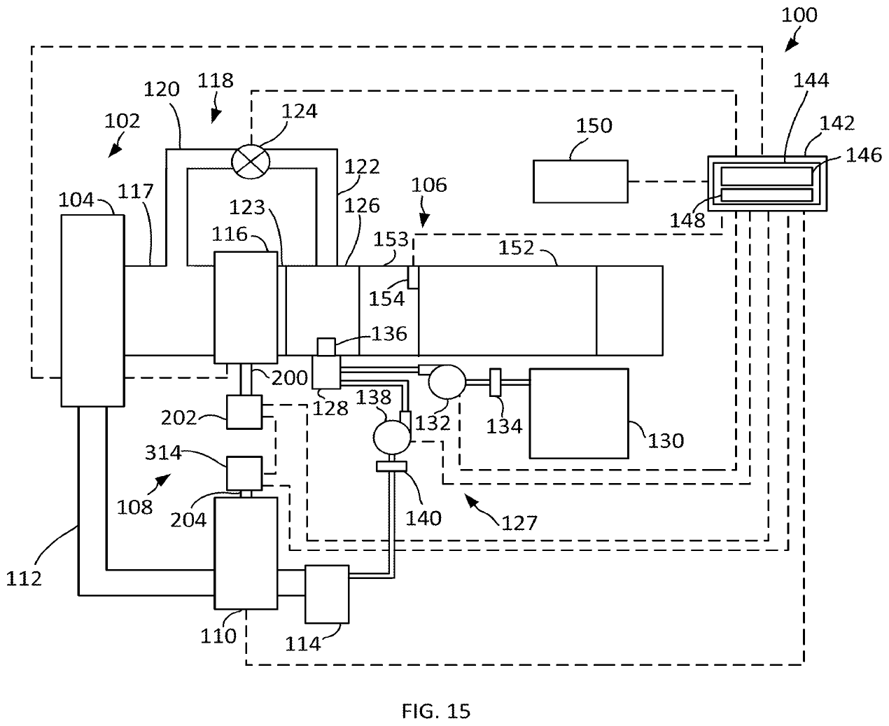

As illustrated in FIG. 15, the turbocharger 108 may include the motor 314 coupled to the compressor shaft 204. The reductant delivery system controller 142 may cause the motor 314 to rotate the compressor wheel 209 via the compressor shaft 204 at a rotational speed that meets the target air-fuel ratio within the internal combustion engine 104 while the motor 202 operates in the driven mode. In some embodiments, the motor 314 may be electrically or communicatively coupled to the electrical load 318 or to the motor 202, such that the motor 314 receives energy generated by the motor 202.

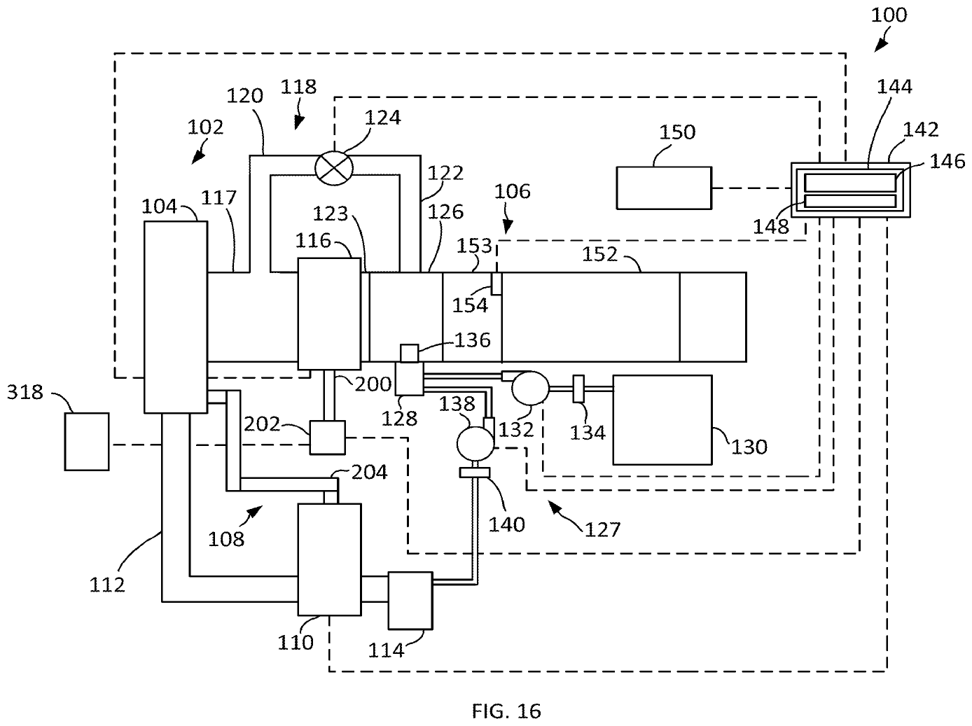

As illustrated in FIG. 16, the compressor shaft 204 may be coupled to the internal combustion engine 104 and configured to rotate according to a power generation (e.g., crankshaft power, etc.) of the internal combustion engine 104. The rotational speed of the compressor 110 will be based on the power generation of the internal combustion engine 104, allowing the internal combustion engine 104 to maintain the target air-fuel ratio.

The turbocharger 108 may include the gearbox 316 coupled to the turbine shaft 200 and the compressor shaft 204. The reductant delivery system controller 142 may be configured to cause the gearbox 316 to select a gear based on the turbine rotational speed. This allows the reductant delivery system controller 142 to (i) cause the motor 202 to rotate the turbine wheel 208 at a turbine rotational speed via the turbine shaft 200 to increase swirling in the exhaust, and (ii) cause the gearbox 316 to select a gear that rotates the compressor wheel 209 via the compressor shaft 204 at a rotational speed associated with the target air-fuel ratio for the internal combustion engine 104.

### III. Overview of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, exhaust, liquid reductant, gaseous reductant, aqueous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. A vehicle system comprising:
a turbocharger comprising:
a turbine configured to receive exhaust from an engine-turbine exhaust conduit,
a shaft coupled to the turbine, and
a motor coupled to the shaft;
a controller configured to cause the motor to rotate the shaft;
an injection housing directly coupled to the turbine or to a turbine-housing exhaust conduit that is directly coupled to the turbine, the injection housing being configured to receive the exhaust from the turbine or from the turbine-housing exhaust conduit; and
a dosing module coupled to the injection housing, the dosing module comprising an injector configured to inject treatment fluid into the injection housing.

2. The vehicle system of claim 1, further comprising:
an engine-compressor air conduit configured to provide air to an engine;
wherein the turbocharger further comprises a compressor coupled to the engine-compressor air conduit and configured to provide the air to the engine-compressor air conduit; and
wherein the shaft is coupled to the compressor.

3. The vehicle system of claim 2, wherein:
the compressor comprises:
an inner portion,
a wheel coupled to the shaft and configured to (i) be received at least partially within the inner portion and (ii) rotate, and
a compressor sensor configured to (i) be received at least partially within the inner portion and (ii) provide a first compressor signal associated with a first rotational speed of the wheel; and
the controller is configured to:
receive the first compressor signal from the compressor sensor,
determine the first rotational speed based on the first compressor signal,
determine a second rotational speed of the wheel based on the first rotational speed of the wheel, the second rotational speed of the wheel greater than the first rotational speed of the wheel, and
cause the motor to rotate the wheel at the second rotational speed.

4. The vehicle system of claim 3, further comprising:
a bypass inlet conduit coupled to the engine-turbine exhaust conduit;
a bypass outlet conduit fluidly coupled to the injection housing; and
a bypass valve coupled to the bypass inlet conduit and the bypass outlet conduit, the bypass valve operable at least between a first position, where flow of the exhaust from the bypass inlet conduit to the bypass outlet conduit is facilitated, and a second position, where the flow of the exhaust from the bypass inlet conduit to the bypass outlet conduit is prohibited,
wherein the controller is configured to cause the bypass valve to operate at the first position after causing the motor to rotate the wheel at the second rotational speed.

5. The vehicle system of claim 4, further comprising:
a heater disposed downstream of the bypass valve and upstream of the bypass outlet conduit, the heater configured to increase a temperature of the exhaust; and
an exhaust sensor disposed downstream of the injection housing and configured to provide an exhaust signal associated with the exhaust,
wherein the controller is further configured to:
receive the exhaust signal from the exhaust sensor,
determine a uniformity index based on the exhaust signal,
determine a target temperature based on the uniformity index, and
cause the heater to operate at the target temperature.

6. The vehicle system of claim 2, further comprising:
a valve disposed downstream of the compressor and upstream of the engine-compressor air conduit, the valve configured to regulate flow of the air from the compressor to the engine-compressor air conduit.

7. The vehicle system of claim 6, wherein:
the valve is a blowoff valve operable at least between a first position, where the flow of the air from the compressor to the engine-compressor air conduit is facilitated, and a second position, where at least a portion of the flow of the air from the compressor is released into an ambient environment; or
the valve is an intake air throttle valve operable at least between a first position, where the flow of the air from the compressor to the engine-compressor air conduit is facilitated, and a second position, where the flow of the air from the compressor to the engine-compressor air conduit is prohibited.

8. The vehicle system of claim 2, further comprising:
a valve disposed downstream of an air source configured to provide the air and upstream of the compressor, the valve configured to regulate flow of the air from the air source to the compressor;
wherein the compressor comprises:
an inner portion,
a wheel coupled to the shaft and configured to (i) be received at least partially within the inner portion and (ii) rotate, and
a compressor sensor configured to (i) be received at least partially within the inner portion and (ii) provide a first compressor signal associated with a rotational speed of the wheel; and
wherein the controller is configured to:
receive the compressor signal from the compressor sensor,
determine the rotational speed based on the compressor signal,
determine a target position based on the rotational speed, and
cause the valve to operate at the target position.

9. The vehicle system of claim 2, further comprising:
a compressor-turbine air conduit coupled to the engine-compressor air conduit and the engine-turbine exhaust conduit; and
a bypass valve disposed within the compressor-turbine air conduit, the bypass valve configured to regulate flow of the air from the engine-compressor air conduit to the engine-turbine exhaust conduit via the compressor-turbine air conduit.

10. The vehicle system of claim 1, further comprising:
a housing-catalyst exhaust conduit directly coupled to the injection housing; and
a selective catalytic reduction (SCR) catalyst member coupled to the housing-catalyst exhaust conduit such that the SCR catalyst member is directly coupled to the turbine.

11. The vehicle system of claim 1, further comprising:
an exhaust sensor downstream of the injection housing and configured to provide (i) a first exhaust signal associated with the exhaust and (ii) a second exhaust signal associated with the exhaust;
wherein the turbine comprises:
an inner portion,
a wheel coupled to the shaft and configured to (i) be received at least partially within the inner portion and (ii) rotate, and
a turbine sensor configured to (i) be received at least partially within the inner portion and (ii) provide a first turbine signal associated with a first rotational speed of the wheel; and
wherein the controller is configured to:
receive the first turbine signal from the turbine sensor,
determine the first rotational speed of the wheel based on the first turbine signal,
receive the first exhaust signal from the exhaust sensor,
determine a first uniformity index based on the first exhaust signal,
determine a second rotational speed of the wheel based on the first rotational speed and the first uniformity index,
cause the motor to rotate the wheel at the second rotational speed,
receive the second exhaust signal from the exhaust sensor after causing the motor to rotate the wheel at the second rotational speed, and
determine a second uniformity index based on the second exhaust signal, the second uniformity index being equal to or greater than the first uniformity index.

12. The vehicle system of claim 11, wherein:
the controller is configured to:
determine a first power output of the turbine based on the first rotational speed of the wheel,
determine a first turbine efficiency based on the first power output,
determine a second power output of the turbine based on the second rotational speed of the wheel, and
determine a second turbine efficiency based on the second power output, the second turbine efficiency being equal to or less than the first turbine efficiency.

13. The vehicle system of claim 1, wherein:
the turbine comprises:
an inner portion,
a wheel coupled to the shaft and configured to (i) be received at least partially within the inner portion and (ii) rotate, and
a turbine sensor configured to (i) be received at least partially within the inner portion and (ii) provide a first turbine signal associated with a first rotational speed of the wheel; and
the controller is configured to:
receive the first turbine signal from the turbine sensor,
determine the first rotational speed of the wheel based on the first turbine signal,
determine a second rotational speed of the wheel based on the first rotational speed of the wheel, and
cause the motor to rotate the wheel at the second rotational speed, wherein the second rotational speed is equal to or less than the first rotational speed.

14. The vehicle system of claim 1, further comprising:
a battery communicable with the motor;
wherein the motor is operable between a driving mode and a driven mode, the motor being configured to:
rotate the shaft in the driving mode, and
produce electricity using rotation of the shaft in the driven mode.

15. The vehicle system of claim 1, further comprising:
a heater disposed around at least a portion of the injection housing, the heater configured to increase a temperature at least one of the exhaust or the treatment fluid in the injection housing; and
an exhaust sensor disposed downstream of the injection housing and configured to provide an exhaust signal associated with the exhaust,
wherein the controller is configured to:
receive the exhaust signal from the exhaust sensor,
determine a uniformity index based on the exhaust signal,
determine a target temperature based on the uniformity index, and
cause the heater to operate at the target temperature.

16. A vehicle system comprising:
a turbocharger comprising:
a turbine configured to receive exhaust from an engine-turbine exhaust conduit,
a turbine shaft coupled to the turbine,
a first motor coupled to the turbine shaft,
a compressor configured to provide air to an engine-compressor air conduit, the engine-compressor air conduit configured to provide the air to an engine, and
a compressor shaft coupled to the compressor, the compressor shaft rotatable independent of the turbine shaft;
a controller configured to cause the first motor to rotate the turbine shaft;
an injection housing directly coupled to the turbine or to a turbine-housing exhaust conduit that is directly coupled to the turbine, the injection housing being configured to receive the exhaust from the turbine or from the turbine-housing exhaust conduit; and
a dosing module coupled to the injection housing, the dosing module comprising an injector configured to inject treatment fluid into the injection housing.

17. The vehicle system of claim 16, further comprising:
an actuator coupled to the turbine shaft and the compressor shaft, the actuator operable to engage and disengage the turbine shaft to the compressor shaft,
wherein the turbine shaft and the compressor shaft have the same rotational speed when engaged by the actuator.

18. The vehicle system of claim 16, further comprising a second motor coupled to the compressor shaft,
wherein the controller is configured to cause the second motor to rotate the compressor shaft.

19. The vehicle system of claim 16, further comprising:
a gearbox coupled to the turbine shaft and the compressor shaft, the gearbox comprising a plurality of gears configured to adjust a compressor rotational speed of the compressor shaft relative to a turbine rotational speed of the turbine shaft.

20. A vehicle system comprising:
an engine comprising:
a crankshaft,
a cylinder-piston assembly configured to rotate the crankshaft, the cylinder piston assembly comprising a cylinder, and
a fuel injector corresponding to the cylinder-piston assembly, the fuel injector configured to inject fuel into the cylinder;
a turbocharger comprising:
a turbine configured to receive exhaust from an engine-turbine exhaust conduit,
a turbine shaft coupled to the turbine,
a first motor coupled to the turbine shaft,
a compressor configured to provide air to an engine-compressor air conduit, the engine-compressor air conduit configured to provide the air to the engine, and
a compressor shaft coupled to the compressor and the crankshaft;
a controller configured to (i) cause the first motor to rotate the turbine shaft and (ii) control fuel amount injected by the fuel injector based on a pressure of the air provided by the compressor to the engine via the engine-compressor air conduit;
an injection housing directly coupled to the turbine or to a turbine-housing exhaust conduit that is directly coupled to the turbine, the injection housing being configured to receive the exhaust from the turbine or from the turbine-housing exhaust conduit; and
a dosing module coupled to the injection housing, the dosing module comprising an injector configured to inject treatment fluid into the injection housing.
